(19) United States
(12) Patent Application Publication
(10) Pub. No.: US 2026/0350282 A1
(43) Pub. Date: Nov. 5, 2026

(54) CIRCUIT SIMULATION VERIFICATION METHOD AND APPARATUS, ELECTRONIC DEVICE, AND NON-TRANSITORY COMPUTER-READABLE STORAGE MEDIUM

(71) Applicant: PRIMARIUS TEHCNOLOGIES CO., LTD., Shanghai (CN)

(72) Inventors: Yu SONG, Shanghai (CN); Haiyang JIA, Shanghai (CN); Jun FANG, Shanghai (CN)

(73) Assignee: PRIMARIUS TEHCNOLOGIES CO., LTD., Shanghai (CN)

(21) Appl. No.: 19/716,201

(22) Filed: Jun. 23, 2026

Related U.S. Application Data
(63) Continuation of application No. PCT/CN2024/137986, filed on Dec. 10, 2024.

(30) Foreign Application Priority Data
Dec. 28, 2023 (CN) 2023118494664

(51) Int. Cl. G06F 30/3308; G06F 30/323

(52) U.S. Cl. CPC G06F 30/3308; G06F 30/323

(57) ABSTRACT

Disclosed are a circuit simulation verification method and apparatus, an electronic device, and a storage medium. The method includes: creating a simulation model for a circuit device, where the simulation model is provided with a timer and a plurality of first simulation points, and the timer is configured to generate second simulation points; obtaining input signals at a current first simulation point and a previous first simulation point during simulation verification; determining whether the input signal at the current first simulation point is the same as the input signal at the previous first simulation point; if not, controlling the timer to periodically generate the second simulation points; and if yes, controlling the simulation model to enter a sleep mode and the timer to stop generating the second simulation points in the sleep mode. The present disclosure can reduce the number of simulation points and improve simulation speed while ensuring accuracy.

### CROSS REFERENCE TO RELATED APPLICATION

The present disclosure is a Continuation of PCT Patent Application No. PCT/CN2024/137986 filed on Dec. 10, 2024, which claims priority of China Patent Application No. 2023118494664 filed on Dec. 28, 2023. The contents of the above-identified applications are incorporated herein by reference.

### TECHNICAL FIELD

The present disclosure relates to the technical field of circuit simulation verification, and in particular to a circuit simulation verification method and apparatus, an electronic device, and a non-transitory computer-readable storage medium.

### BACKGROUND

In recent years, with the rapid development of wireless communication technology, higher demands have been placed on the related integrated circuits, requiring superior signal processing capabilities and shorter product development cycles. Taking a radio frequency integrated circuit as an example, the circuit primarily consists of active devices such as transistors and passive devices such as inductors and capacitors. According to traditional design methods, designers first establish the performance parameters of the integrated circuit based on system requirements, determine a circuit topology, and design a schematic. Circuit simulation is then performed to verify the correctness of the schematic parameter design. Next, the layout is drawn based on the circuit schematic. After the layout is completed, a layout-versus-schematic check is carried out to ensure the correctness of the layout. Subsequently, parasitic parameters are extracted from the layout for post-layout simulation. If the post-layout simulation results are unsatisfactory, the designers return to the schematic to optimize the design parameters, modify the corresponding layout accordingly. Thereafter, parasitic parameters are extracted from the modified layout, and post-layout simulation is performed again. Once the post-layout simulation results meet design expectations, the layout is sent to a foundry for chip fabrication.

During simulation verification, a timer periodically generates a simulation point. At the moment of each simulation point, a simulation tool inserts trigger events to execute corresponding simulation events. In other words, at the moment of each simulation point, the simulation tool must perform detailed calculations, such as solving for node voltages and branch currents of various parts of the circuit by establishing circuit equations and performing Newton iterations. Since each simulation point requires a large amount of mathematical calculations, the greater the number of simulation points, the more total time the simulation tool spends on calculations. When the timer operates at a high frequency or high simulation accuracy is required, a simulation model generates a large number of simulation points, which severely impacts simulation speed.

### SUMMARY

In view of this, the present disclosure provides a circuit simulation verification method and apparatus, an electronic device, and a non-transitory computer-readable storage medium, which can address the problem of an increasing number of simulation points and the resulting impact on simulation speed.

A circuit simulation verification method provided by the present disclosure includes:
creating a simulation model for a circuit device by using a hardware description language, where the simulation model is provided with a timer and a plurality of first simulation points, and the timer is configured to generate second simulation points;
obtaining input signals at a current first simulation point and at a previous first simulation point during simulation verification;
determining whether the input signal at the current first simulation point is the same as the input signal at the previous first simulation point;
if not, controlling the timer to periodically generate the second simulation points; and
if yes, controlling the simulation model to enter a sleep mode and the timer to stop generating the second simulation points in the sleep mode.

Optionally, the input signal includes at least one of voltage, current, frequency, and power.

Optionally, the circuit device is not provided with an excitation source, and during simulation verification, an output signal thereof remains constant when the input signal of the simulation model remains unchanged.

Optionally, a method for determining whether the circuit device is provided with an excitation source includes: obtaining all assignment statements in the simulation model;
when the input signal of the simulation model remains unchanged, determining, based on the assignment statements, whether variable values corresponding to two adjacent first simulation points have an association relationship;
if yes, determining that the circuit device is provided with an excitation source; and
if not, determining that the circuit device is not provided with an excitation source.

Optionally, after the sleep mode, if it is determined that the input signal at the current first simulation point is different from the input signal at the previous first simulation point, controlling the timer to periodically generate the second simulation points includes:
controlling the timer to obtain time points for generating the second simulation points according to a relational expression of t₂=n*T+t₁; where t₂ is a time point for generating a second simulation point, n≥1 and n is a positive integer, T is a period set by the timer itself for generating the second simulation points, and t₁ is a time point for the timer to generate a last second simulation point prior to the sleep mode.

Optionally, the hardware description language includes a Verilog-AMS modeling language.

Optionally, the types of trigger events inserted at each of the first simulation points are different or partially identical, and the types of trigger events inserted at each of the second simulation points are the same.

A circuit simulation verification apparatus provided by the present disclosure includes:
a creation module configured to create a simulation model for a circuit device using a hardware description language, where the simulation model is provided with a timer and a plurality of first simulation points, and the timer is configured to generate second simulation points;
an obtaining module configured to obtain input signals at a current first simulation point and a previous first simulation point during simulation verification;
a determination module configured to determine whether the input signal at the current first simulation point is the same as the input signal at the previous first simulation point;
a control module configured to control the timer to periodically generate the second simulation points when the input signal at the current first simulation point is different from the input signal at the previous first simulation point; and to control, when the input signal at the current first simulation point is the same as the input signal at the previous first simulation point, the simulation model to enter a sleep mode and the timer to stop generating the second simulation points in the sleep mode; and
an insertion module configured to insert trigger events at the second simulation points.

An electronic device provided by the present disclosure includes:
a processor; and
a memory configured to store instructions executable by the processor;
where the processor is configured to execute the instructions to perform any one of the circuit simulation verification methods described above.

A non-transitory computer-readable storage medium provided by the present disclosure stores a computer program, and when executed by a processor, causes the processor to perform any one of the circuit simulation verification methods described above.

As described above, when the simulation model enters the sleep mode, the timer stops generating the second simulation points. This reduces the number of simulation points, helps to improve simulation speed, and shortens the simulation verification cycle for an integrated circuit containing high-frequency triggered clock events (i.e., timer events), thereby accelerating the design iteration of the entire integrated circuit and facilitating earlier tape-out for production.

Furthermore, since no excitation source is arranged for the circuit device, the input signal of the simulation model remains unchanged during the simulation verification. Consequently, the output signal also remains constant, thereby ensuring the simulation accuracy.

### BRIEF DESCRIPTION OF DRAWINGS

FIG. 1 is a schematic flowchart of a circuit simulation verification method according to an embodiment of the present disclosure;

FIG. 2 is a timing diagram of a circuit simulation verification provided based on the method shown in FIG. 1; and

FIG. 3 is a schematic structural diagram of a circuit simulation verification apparatus according to an embodiment of the present disclosure.

### DETAILED DESCRIPTION OF THE EMBODIMENTS

To solve the aforementioned problems existing in the prior art, the present disclosure provides a circuit simulation verification method and apparatus, an electronic device, and a non-transitory computer-readable storage medium. These claimed subject matters share the same inventive concept and adopt substantially identical or similar technical principles for solving the problems. The implementations of each claimed subject matter may be cross-referenced, and repetitive descriptions are therefore omitted.

To clarify the objectives, technical solutions and advantages of the present disclosure, the following description sets forth the technical solutions of the present disclosure in detail with reference to specific embodiments and accompanying drawings. Apparently, the embodiments described below are merely some but not all of the embodiments of the present disclosure. Where there is no conflict, the respective embodiments and their technical features may be combined, and the combinations are embraced by the technical solutions herein.

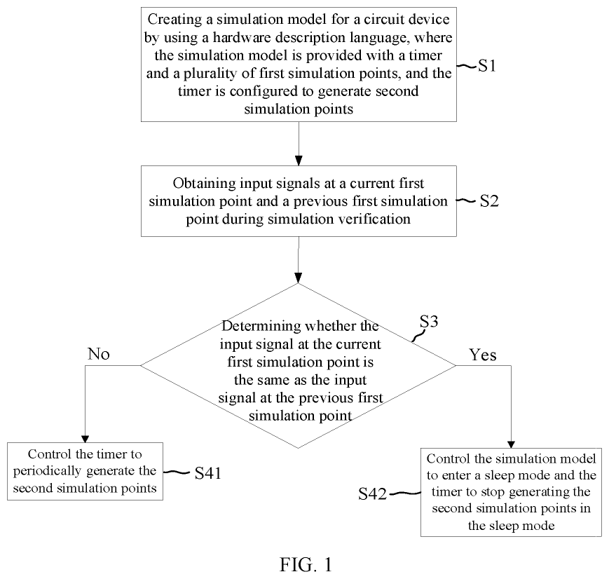

FIG. 1 is a schematic flowchart of a circuit simulation verification method according to an embodiment of the present disclosure. The circuit to which the method is applicable may also be referred to as an integrated circuit, including but not limited to a radio frequency integrated circuit. The integrated circuit may be fabricated using semiconductor integrated circuit process technologies and features small size, low power consumption, and high reliability. The integrated circuit may be provided with at least one circuit device such as a low-noise amplifier, a power amplifier, an oscillator, and a mixer, and its operating frequency may range from several hundred MHz to several GHz or even several tens of GHz. An entity executing the method may be a simulation tool, which is configured to simulate the circuit (including, of course, all or part of the circuit devices contained therein).

As shown in FIG. 1, the circuit simulation verification method includes the following steps.
S1: Creating a simulation model for a circuit device by using a hardware description language, where the simulation model is provided with a timer and a plurality of first simulation points, and the timer is configured to generate second simulation points.

In one embodiment of the present disclosure, a netlist file of the circuit may first be obtained, where this netlist file is at least used to describe the topology, excitation signals, simulation parameters, etc. of the circuit and circuit devices to be simulated. Subsequently, a simulation model for the circuit device may be created by using a Verilog-AMS modeling language, so as to perform simulation verification on analog signal circuits or mixed-signal circuits.

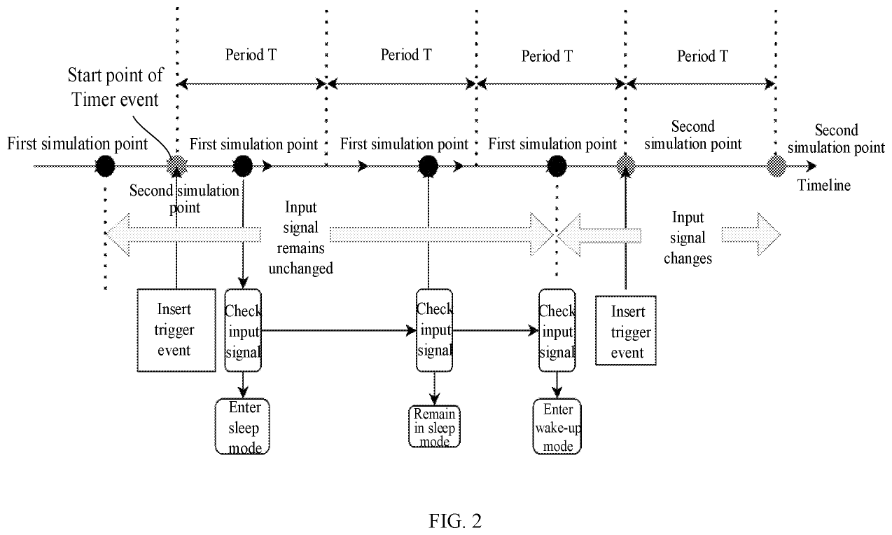

As shown in FIG. 2, throughout the simulation verification process, as the simulation progresses along the timeline, the simulation tool sequentially generates a plurality of first simulation points in chronological order. At the moment of each first simulation point, the simulation tool can trigger any event other than those triggered by the timer, including but not limited to: changes in electrical parameters originating from voltage sources, piecewise linear (PWL) transitions generated by voltage sources, simulation tool-internal events requiring Newton iterations for parameter calculations. The generation of each first simulation point is predefined by the simulation tool according to the simulation progress. The types of trigger events inserted at each first simulation point are different or only partially the same, and cannot be all identical. A time duration between any two adjacent first simulation points does not follow a periodic pattern.

The second simulation points generated by the timer follow a specific periodic pattern, namely, a time duration t between any two adjacent second simulation points must satisfy t=m*T, where m is a positive integer and T is a period set by the timer itself for generating the second simulation points, which may also be referred to as a minimum time duration between adjacent second simulation points. In addition, at the moment of each second simulation point, the types of trigger events inserted by the simulation tool may be the same, which is a major distinction from the first simulation points.
S2: Obtaining input signals at a current first simulation point and a previous first simulation point during simulation verification.

When an input signal is received at each first simulation point, the above-mentioned S2 may be executed.

The input signal refers to an electrical signal received by the circuit device. To facilitate the comparison in S3 described below, electrical parameters corresponding to the electrical signal may be obtained, where the electrical parameters include, but are not limited to, at least one of voltage, current, frequency, and power.
S3: Determining whether the input signal at the current first simulation point is the same as the input signal at the previous first simulation point.

That is, electrical parameters of the same type are compared; if the values of the same type of electrical parameters are equal, it indicates that the input signals are the same; otherwise, it indicates that the input signals are different.

If not, perform S41: control the timer to periodically generate the second simulation points.

If yes, perform S42: control the simulation model to enter a sleep mode and the timer to stop generating the second simulation points in the sleep mode.

Continuing with the scenario shown in FIG. 2 as an example, when an input signal is received at a second first simulation point (i.e., a corresponding trigger event is received at the moment of the second first simulation point), the input signal received at the second first simulation point is compared with the input signal received at a first first simulation point. If they are the same, the simulation model enters the sleep mode, and at this time, the timer stops generating the second simulation points. As the simulation verification process progresses, once it is detected that the input signal at a first simulation point has changed, for example, if an input signal received at an x-th first simulation point is different from an input signal received at an (x−1)-th first simulation point, the simulation model is controlled to exit the sleep mode and enter a wake-up mode. After the moment of the x-th first simulation point, the above-mentioned S41 is executed, i.e., the timer periodically generates the second simulation points according to its own settings.

As described above, after the circuit device enters the sleep mode, the timer is no longer triggered, and no new simulation points (i.e., the second simulation points) are additionally inserted. When a next first simulation point arrives, the simulation tool checks the input signal again. If the input signal of the circuit device remains unchanged, it continues to remain in the sleep mode until a change in the input signal is detected after the trigger event corresponding to a certain first simulation point has ended (alternatively, when an input signal is received at a certain first simulation point). At that time, the circuit device is awakened from a sleep state.

According to the present disclosure, when the simulation model enters the sleep mode, the timer stops generating the second simulation points. This reduces the number of simulation points, helps to improve simulation speed, and shortens the simulation verification cycle for an integrated circuit containing high-frequency triggered clock events (i.e., timer events), thereby accelerating the design iteration of the entire integrated circuit, and facilitating earlier tape-out for production.

After the sleep mode, if it is determined that the input signal at the current first simulation point is different from the input signal at the previous first simulation point, then in the above-mentioned S41, it is necessary to determine the time points (i.e., moments) at which the second simulation points are generated. Optionally, the method for determining the time points at which the second simulation points are generated includes: controlling the timer to obtain time points for generating the second simulation points according to a relational expression of t₂=n*T+t₁; where t₂ is a time point for generating a second simulation point, n≥1 and n is a positive integer, T is a period set by the timer itself for generating the second simulation points, and t₁ is a time point for the timer to generate a last second simulation point prior to the sleep mode.

Optionally, a time point t₂₁ of a first second simulation point after entering the wake-up mode further meets a relational expression (t₂₁−t₃)<T, i.e., a time duration between t₂ and a time point t₃ of a most recent first simulation point preceding the first second simulation point in the wake-up mode is less than the period T of the timer.

The circuit device to which the present disclosure is applicable may not be provided with an excitation source, i.e., a power supply that provides the input signal to the circuit device; in this case, the output (i.e., the above-mentioned output signal) of the circuit device is determined by external inputs. During simulation verification, when the input signals of the simulation model remain unchanged, the output signals thereof also remain constant, thereby ensuring the simulation accuracy.

In one embodiment, the aforementioned method may further include: determining whether the circuit device is provided with an excitation source; if yes, terminating the process; and if not, executing the above-mentioned S2 to S3.

A method for determining whether the circuit device is provided with an excitation source optionally includes:
S21: obtaining all assignment statements in the simulation model;
S22: when the input signals of the simulation model remain unchanged, determining, based on the assignment statements, whether variable values corresponding to two adjacent first simulation points have an association relationship; and
if yes, perform S231: determine that the circuit device is provided with an excitation source;
if not, perform S232: determine that the circuit device is not provided with an excitation source.

Taking output signals at respective first simulation points as starting points, the simulation tool checks all assignment statements in the simulation model. If it is found that, when the input signal at the respective first simulation point remains unchanged, the output signal of the current first simulation point is influenced by a variable value associated with the previous first simulation point, and this indicates that the circuit device is a device provided with its own excitation source; otherwise, it indicates that the circuit device itself is not provided with an excitation source.

The variable value for executing the above-mentioned S22 may be adapted according to actual requirements, such as at least one of voltage, current, resistance, frequency, and power.

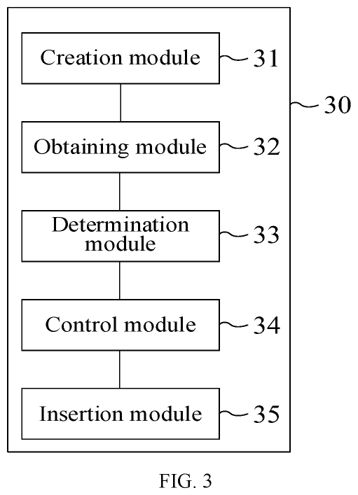

As shown in FIG. 3, an embodiment of the present disclosure further provides a circuit simulation verification apparatus 30, including:
a creation module 31 configured to create a simulation model for a circuit device by using a hardware description language, where the simulation model is provided with a timer and a plurality of first simulation points, and the timer is configured to generate second simulation points;
an obtaining module 32 configured to obtain input signals at a current first simulation point and at a previous first simulation point during simulation verification;
a determination module 33 configured to determine whether the input signal at the current first simulation point is the same as the input signal at the previous first simulation point;
a control module 34 configured to control the timer to periodically generate the second simulation points when the input signal at the current first simulation point is different from the input signal at the previous first simulation point; and to control, when the input signal at the current first simulation point is the same as the input signal at the previous first simulation point, the simulation model to enter a sleep mode and the timer to stop generating the second simulation points in the sleep mode; and
an insertion module 35 configured to insert trigger events at the second simulation points.

The present disclosure further provides an electronic device, including a memory and a processor. The memory stores instructions, for example, circuit simulation verification instructions. When executed by the processor, the circuit simulation verification instructions perform the steps corresponding to the circuit simulation verification method according to any of the above embodiments.

The specific form of the electronic device is not limited by the present disclosure.

An embodiment of the present disclosure further provides a non-transitory computer-readable storage medium. The non-transitory computer-readable storage medium stores a computer program. When executed by a processor, the computer program performs the steps corresponding to the circuit simulation verification method according to any of the embodiments.

The non-transitory computer-readable storage medium may include: a read-only memory (ROM), a random access memory (RAM), a magnetic disk, an optical disk, or the like.

Since the instructions stored in the non-transitory computer-readable storage medium can execute the steps in any of the circuit simulation verification methods provided in the embodiments of the present disclosure, the beneficial effects achievable by any of the circuit simulation verification methods provided in the embodiments of the present disclosure can be realized. For details, reference is made to the preceding embodiments, and repeated description is omitted herein.

Furthermore, the circuit simulation verification apparatus 30, the electronic device, and the non-transitory computer-readable storage medium provided in the embodiments of the present disclosure are each complete devices and also have structures correspondingly possessed by known devices. The present disclosure only exemplarily describes some structural elements related to circuit simulation verification, and does not list other structural elements one by one.

The above descriptions are merely some embodiments of the present disclosure and do not limit the patent scope of the present disclosure. For those skilled in the art, any equivalent structural changes made according to the specification and the accompanying drawings of the present disclosure shall fall within the scope of patent protection of the present disclosure.

Although terms such as “first”, “second”, and the like are used herein to describe various information, such information should not be limited by these terms. These terms are used solely to distinguish information of the same type from one another. Furthermore, the singular forms “a”, “an”, and “the” are intended to include the plural forms as well. The terms “or” and “and/or” are to be interpreted as inclusive, meaning either one or any combination thereof. Exceptions to this definition occur only when a combination of elements, functions, steps, or operations is inherently mutually exclusive in some manner.

What is claimed is:

1. A circuit simulation verification method, wherein the method comprises:
creating a simulation model for a circuit device by using a hardware description language, wherein the simulation model is provided with a timer and a plurality of first simulation points, and the timer is configured to generate second simulation points;
obtaining input signals at a current first simulation point and at a previous first simulation point during simulation verification;
determining whether the input signal at the current first simulation point is the same as the input signal at the previous first simulation point;
if not, controlling the timer to periodically generate the second simulation points; and
if yes, controlling the simulation model to enter a sleep mode and the timer to stop generating the second simulation points in the sleep mode.

2. The method according to claim 1, wherein the input signal comprises at least one of voltage, current, frequency, and power.

3. The method according to claim 1, wherein the circuit device is not provided with an excitation source, and during simulation verification, an output signal thereof remains constant when an input signal of the simulation model remains unchanged.

4. The method according to claim 3, wherein the method for determining whether the circuit device is provided with an excitation source comprises:
obtaining all assignment statements in the simulation model;
when the input signals of the simulation model remain unchanged, determining, based on the assignment statements, whether variable values corresponding to two adjacent first simulation points have an association relationship;
if yes, determining that the circuit device is provided with an excitation source; and
if not, determining that the circuit device is not provided with an excitation source.

5. The method according to claim 1, wherein after the sleep mode, if it is determined that the input signal at the current first simulation point is different from the input signal at the previous first simulation point, controlling the timer to periodically generate the second simulation points comprises:
controlling the timer to obtain time points for generating the second simulation points according to a relational expression of t₂=n*T+t₁; wherein t₂ is a time point for generating a second simulation point, n≥1 and n is a positive integer, T is a period set by the timer itself for generating the second simulation points, and t₁ is a time point for the timer to generate a last second simulation point prior to the sleep mode.

6. The method according to claim 1, wherein the hardware description language comprises a Verilog-AMS modeling language.

7. The method according to claim 1, wherein the types of trigger events inserted at each of the first simulation points are different or partially the same, and the types of trigger events inserted at each of the second simulation points are the same.

8. An electronic device, wherein the electronic device comprises a memory and a processor, the memory stores instructions, and the processor is configured to execute the instructions to cause the electronic device to perform the following operations:
creating a simulation model for a circuit device by using a hardware description language, wherein the simulation model is provided with a timer and a plurality of first simulation points, and the timer is configured to generate second simulation points;
obtaining input signals at a current first simulation point and at a previous first simulation point during simulation verification;
determining whether the input signal at the current first simulation point is the same as the input signal at the previous first simulation point;
if not, controlling the timer to periodically generate the second simulation points; and
if yes, controlling the simulation model to enter a sleep mode and the timer to stop generating the second simulation points in the sleep mode.

9. The electronic device according to claim 8, wherein the input signal comprises at least one of voltage, current, frequency, and power.

10. The electronic device according to claim 8, wherein the circuit device is not provided with an excitation source, and during simulation verification, an output signal thereof remains constant when an input signal of the simulation model remains unchanged.

11. The electronic device according to claim 10, wherein the method for determining whether the circuit device is provided with an excitation source comprises:
obtaining all assignment statements in the simulation model;
when the input signals of the simulation model remain unchanged, determining, based on the assignment statements, whether variable values corresponding to two adjacent first simulation points have an association relationship;
if yes, determining that the circuit device is provided with an excitation source; and
if not, determining that the circuit device is not provided with an excitation source.

12. The electronic device according to claim 8, wherein after the sleep mode, if it is determined that the input signal at the current first simulation point is different from the input signal at the previous first simulation point, controlling the timer to periodically generate the second simulation points comprises:
controlling the timer to obtain time points for generating the second simulation points according to a relational expression of t₂=n*T+t₁; wherein t₂ is a time point for generating a second simulation point, n≥1 and n is a positive integer, T is a period set by the timer itself for generating the second simulation points, and t₁ is a time point for the timer to generate a last second simulation point prior to the sleep mode.

13. The electronic device according to claim 8, wherein the hardware description language comprises a Verilog-AMS modeling language.

14. The electronic device according to claim 8, wherein the types of trigger events inserted at each of the first simulation points are different or partially the same, and the types of trigger events inserted at each of the second simulation points are the same.

15. A non-transitory computer-readable storage medium, wherein the non-transitory computer-readable storage medium stores a computer program, and when executed by a processor, the computer program causes the processor to perform the following operations:
creating a simulation model for a circuit device by using a hardware description language, wherein the simulation model is provided with a timer and a plurality of first simulation points, and the timer is configured to generate second simulation points;
obtaining input signals at a current first simulation point and at a previous first simulation point during simulation verification;
determining whether the input signal at the current first simulation point is the same as the input signal at the previous first simulation point;
if not, controlling the timer to periodically generate the second simulation points; and
if yes, controlling the simulation model to enter a sleep mode and the timer to stop generating the second simulation points in the sleep mode.

16. The non-transitory computer-readable storage medium according to claim 15, wherein the input signal comprises at least one of voltage, current, frequency, and power.

17. The non-transitory computer-readable storage medium according to claim 15, wherein the circuit device is not provided with an excitation source, and during simulation verification, an output signal thereof remains constant when the input signal of the simulation model remains unchanged.

18. The non-transitory computer-readable storage medium according to claim 17, wherein the method for determining whether the circuit device is provided with an excitation source comprises:
obtaining all assignment statements in the simulation model;
when the input signals of the simulation model remain unchanged, determining, based on the assignment statements, whether variable values corresponding to two adjacent first simulation points have an association relationship;
if yes, determining that the circuit device is provided with an excitation source; and
if not, determining that the circuit device is not provided with an excitation source.

19. The non-transitory computer-readable storage medium according to claim 15, wherein after the sleep mode, if it is determined that the input signal at the current first simulation point is different from the input signal at the previous first simulation point, controlling the timer to periodically generate the second simulation points comprises:
controlling the timer to obtain time points for generating the second simulation points according to a relational expression of t₂=n*T+t₁; wherein t₂ is a time point for generating a second simulation point, n≥1 and n is a positive integer, T is a period set by the timer itself for generating the second simulation points, and t₁ is a time point for the timer to generate a last second simulation point prior to the sleep mode.

20. The non-transitory computer-readable storage medium according to claim 15, wherein the types of trigger events inserted at each of the first simulation points are different or partially the same, and the types of trigger events inserted at each of the second simulation points are the same.
